(19) United States
(12) Patent Application Publication
(10) Pub. No.: US 2026/0119648 A1
(43) Pub. Date: Apr. 30, 2026

(54) MALICIOUS SOFTWARE MITIGATION

(71) Applicant: Arms Cyber Defense, Inc., Franklin, TN (US)

(72) Inventors: Bradley David Potteiger, Baltimore, MD (US); Michael Charles Bryant, Brentwood, TN (US); Timothy Ryan Potteiger, Baltimore, MD (US); David William Potteiger, Pasadena, MD (US); Chris Hunter-Salas, Nashville, TN (US)

(21) Appl. No.: 18/926,262

(22) Filed: Oct. 24, 2024

(51) Int. Cl. G06F 21/55

(52) U.S. Cl. CPC G06F 21/554; G06F 2221/033

(57) ABSTRACT

Various embodiments of methods, systems and computer program products described herein are directed to a Filter Engine. The Filter Engine includes a supervisor component and one or more File Input/Output (“I/O”) filters. The Filter Engine instantiates one or more file input/output (“file I/O”) filter modules that correspond with a file system, each respective file I/O module assigned to a different type of file system operation. A first file I/O filter module is assigned to a first type of file system operation. Prior to execution of an instance of a first type of file system operation: (i) a first file I/O filter module detects a first call for the instance of the first type of file system operation and determines whether to provide access to file system decoy data to a source of the first call.

### BACKGROUND

With the rise of ransomware over the past several years, it is easier than ever for attackers to wreak havoc on unsuspecting organizations. This damage has expanded from government organizations to large enterprises to small businesses alike. A foundational principle behind these attacks is the concept of a ransom payment. By encrypting user files on the endpoint to render them inaccessible, attackers can hit on organizational pain points such as loss of business, system downtime, and safety concerns. Attackers today hope that the longer these pain points last for these organizations, the more likely they will pay the attackers a ransom payment to unencrypt the files. This makes the ransom payment the lifeblood of the attacker, allowing them to survive from a business perspective. Without these payments, attackers wouldn't have the incentive to execute these types of attacks. Most businesses assume that by paying the ransom payment, they can quickly wipe their hands of the attack and move on, but a lot of the time the true cost is magnitudes of this initial number after combining the total direct and indirect factors.

### SUMMARY

Many conventional technologies can amplify the problem further. With the evolution and adoption of evasive and adaptive tactics using Generative AI and obfuscation, it becomes increasingly important to use defense in depth defensive tactics to inhibit quick exploitation advancements. Generative AI and obfuscation have allowed attackers to better disguise their payloads to bypass existing antivirus (AV) and Endpoint Detection Response (EDR) platforms, both of which tend to rely heavily on static signature detection of files and behaviors for proactive detection.

Various real-time detection approaches can more adeptly catch attempts to modify the targeted facets of the system under attack. As an example, specific folders may be expected to change with minimal frequency and files within other folders can be designed to change minimally or within a set of expected constraints, meaning any behavior outside of these bounds constitutes suspicious or malicious behavior. Yet, for a signature-based approach, there are enumerable permutations of tactics that can lead up to the actual damaging operation. It is important to note that from a timing basis, real-time detection mechanisms also have the benefit to serve as synchronous components, while reactive components do not. This means that by the time these signals are picked up, the attack is paused until a verdict about the indicator of compromise (IOC) is reached.

Various embodiments of methods, systems and computer program products described herein are directed to an Filter Engine that ensures that various files that are soon to be encrypted by a malicious program or ransomware have to be validated before any malicious program or ransomware is able to perform its encryption operations on those various files.

The Filter Engine includes a supervisor component and one or more File Input/Output (“I/O”) filters. The Filter Engine instantiates one or more file input/output (“file I/O”) filter modules that correspond with a file system, each respective file I/O module assigned to a different type of file system operation. A first file I/O filter module is assigned to a first type of file system operation. Prior to execution of an instance of a first type of file system operation: (i) a first file I/O filter module detects a first call for the instance of the first type of file system operation and determines whether to provide access to file system decoy data to a source of the first call.

According to various embodiments, the Filter Engine includes any number of file I/O filter modules whereby each respective file I/O filter module is assigned to intercepting a request for a different type of file system operation.

According to various embodiments, the supervisor component receives intercepted file system operation requests routed by the one or more file I/O filter modules. The supervisor component determines whether an intercepted request is called from a source associated with a program that does or does not appear on an allowed programs list. It is understood that a source may be a program, a thread or a process.

According to various embodiments, a file I/O filter module(s) provides access to a source of an intercepted file system operation request due to the source corresponding to a program that is absent from the allowed programs list.

According to various embodiments, a file I/O filter module(s) baits the source to into making requests for one or more file system operation calls on a decoy file. The file I/O filter module(s) terminates the source in response to intercepting file system operation calls for the decoy file.

According to various embodiments, due to the source not interacting with the decoy file, a file I/O filter module(s) performs file attribute analysis on the results of subsequent file system activities of the source in order to determine whether the source is associated with a malicious program or ransomware.

Further areas of applicability of the present disclosure will become apparent from the detailed description, the claims and the drawings. The detailed description and specific examples are intended for illustration only and are not intended to limit the scope of the disclosure.

### BRIEF DESCRIPTION OF THE DRAWINGS

The present disclosure will become better understood from the detailed description and the drawings, wherein:

FIG. 1 is a diagram illustrating an exemplary environment in which some embodiments may operate.

FIG. 2 is a diagram illustrating an exemplary environment in which some embodiments may operate.

FIG. 3A is a diagram illustrating an exemplary method that may be performed in some embodiments.

FIG. 3B is a diagram illustrating an exemplary method that may be performed in some embodiments.

FIG. 4 is a diagram illustrating an exemplary environment in which some embodiments may operate.

FIG. 5 is a diagram illustrating an exemplary environment in which some embodiments may operate.

FIG. 6 is a diagram illustrating an exemplary environment in which some embodiments may operate.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

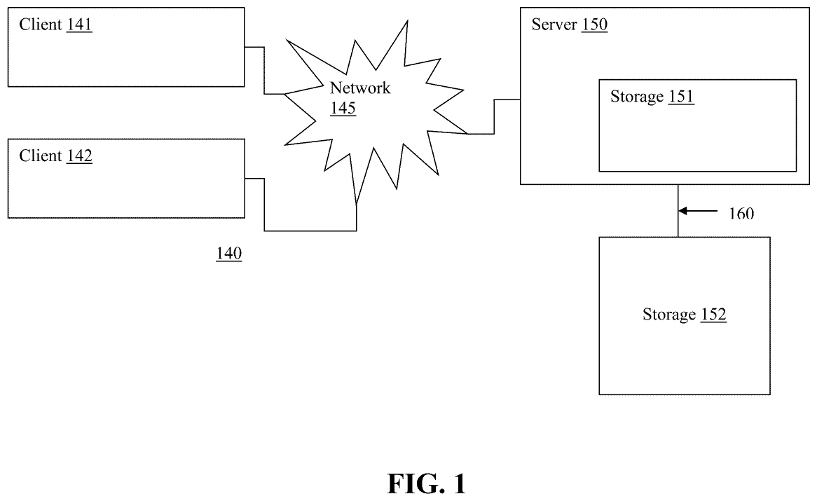

A diagram of exemplary network environment in which embodiments may operate is shown in FIG. 1. In the exemplary environment 140, two clients 141, 142 are connected over a network 145 to a server 150 having local storage 151. Clients and servers in this environment may be computers. Server 150 may be configured to handle requests from clients.

The exemplary environment 140 is illustrated with only two clients and one server for simplicity, though in practice there may be more or fewer clients and servers. The computers have been termed clients and servers, though clients can also play the role of servers and servers can also play the role of clients. In some embodiments, the clients 141, 142 may communicate with each other as well as the servers. Also, the server 150 may communicate with other servers.

The network 145 may be, for example, local area network (LAN), wide area network (WAN), telephone networks, wireless networks, intranets, the Internet, or combinations of networks. The server 150 may be connected to storage 152 over a connection medium 160, which may be a bus, crossbar, network, or other interconnect. Storage 152 may be implemented as a network of multiple storage devices, though it is illustrated as a single entity. Storage 152 may be a file system, disk, database, or other storage.

In an embodiment, the client 141 may perform the method 200 or other method herein and, as a result, store a file in the storage 152. This may be accomplished via communication over the network 145 between the client 141 and server 150. For example, the client may communicate a request to the server 150 to store a file with a specified name in the storage 152. The server 150 may respond to the request and store the file with the specified name in the storage 152. The file to be saved may exist on the client 141 or may already exist in the server's local storage 151. In another embodiment, the server 150 may respond to requests and store the file with a specified name in the storage 151. The file to be saved may exist on the client 141 or may exist in other storage accessible via the network such as storage 152, or even in storage on the client 142 (e.g., in a peer-to-peer system).

In accordance with the above discussion, embodiments can be used to store a file on local storage such as a disk or on a removable medium like a flash drive, CD-R, or DVD-R. Furthermore, embodiments may be used to store a file on an external storage device connected to a computer over a connection medium such as a bus, crossbar, network, or other interconnect. In addition, embodiments can be used to store a file on a remote server or on a storage device accessible to the remote server.

Furthermore, cloud computing is another example where files are often stored on remote servers or remote storage systems. Cloud computing refers to pooled network resources that can be quickly provisioned so as to allow for easy scalability. Cloud computing can be used to provide software-as-a-service, platform-as-a-service, infrastructure-as-a-service, and similar features. In a cloud computing environment, a user may store a file in the “cloud,” which means that the file is stored on a remote network resource though the actual hardware storing the file may be opaque to the user.

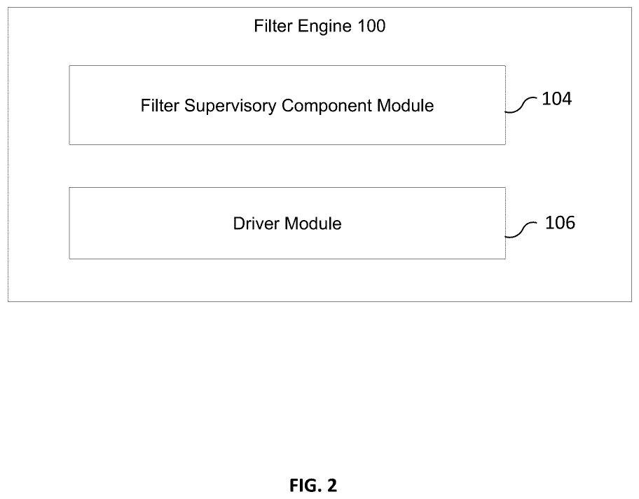

FIG. 2 illustrates a block diagram of an example system 100 for a Filter Engine that includes a filter supervisory component module 104, filter driver module 106.

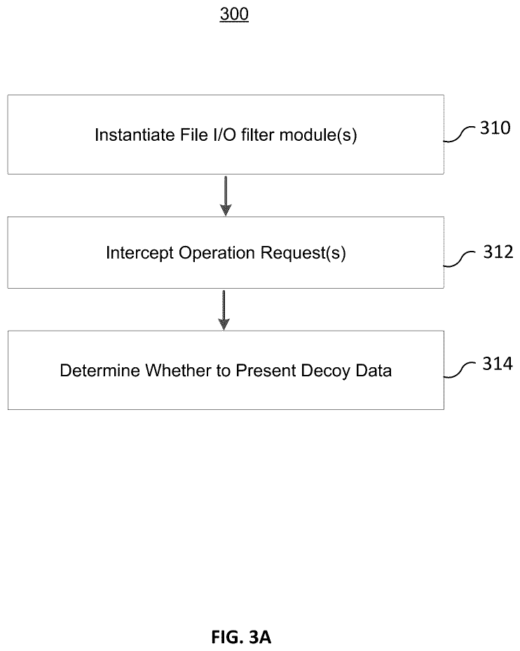

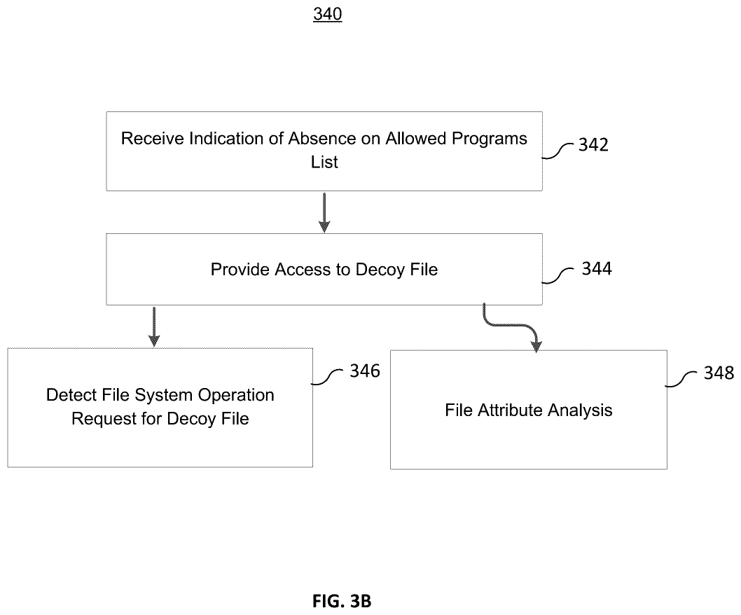

The filter supervisory component module 104 may perform functionality as illustrated in FIGS. 3A, 3B, 4 and 5.

The driver module 106 may instantiate file I/O filters and assign the filters to various types of file system operations. The filter driver module 106 and/or one or more file I/O filters may perform functionality as illustrated in FIGS. 3A, 3B, 4 and 5.

As shown flowchart 300 in FIG. 3A, the Filter Engine instantiates one or more File I/O filter modules (step 310). In various embodiments, a file filter driver is installed in kernel space of a computer system and a supervisor component is installed in user space of the computer system. The computer system's file system is held in kernel space. The Filter instantiates on or more File I/O filter modules (or “File I/O filters”) in kernel space, whereby each File I/O filter is assigned to a particular type of files system operation. For example, a first File I/O filter is a Write File I/O filter defined for intercepting instances of write calls, a second File I/O filter is a Read File I/O filter defined for intercepting instances of read calls and a third File I/O filter is an Enumeration File I/O filter defined for intercepting instances of file enumeration requests. It is understood that the Filter provides for instantiation of many different File I/O filters defined for intercepting any type of file system operation call or request.

The Filter Engine intercepts one or more operation requests (step 312) and determines whether to present decoy data (step 314). A first source, such as a first process, requests to perform a file system operation with respect to a folder of the file system that includes one or more files. The Enumeration File I/O filter intercepts an enumeration request from the first process and routes the intercepted request to the supervisor component. The supervisor component validates whether the first process is associated with a program on an allowed programs list. If validation occurs, the supervisor component sends a message to the Enumeration File I/O filter indicating the first process is not related to a malicious program or ransomware because the program to which the first process corresponds is present on the allowed programs list. In response to the message, the Enumeration File I/O filter returns a first application view of the folder to the first process, wherein the first application view of the folder does not include a decoy file. That is, since the first process has been validated by the supervisor component, a decoy file is not provided in the first application view because the first process is associated with a program that is on the allowed programs list and, therefore, deemed as a trusted first process. It is understood that validation and presentation of the first application view occurs prior to initiation or execution of the enumeration operation by the first process.

As shown in diagram 340 of FIG. 3B, the Filter Engine receives an indication of absence of the source on the allowed programs list (Step 342). For example, a Read File I/O filter may intercept a request for a read file system operation from a second source, such as a second process. The Read File I/O filter routes the intercepted read request to the supervisor component. The Read File I/O filter receives a message from the supervisor component indicating the second process is associated with a program that is not present on the allowed programs list. Because not being present on the allowed programs list does not necessarily mean that a particular program is, in fact, malicious, the supervisor component sends a warning message indicating the second process is suspicious to the Read File I/O filter.

The Filter Engine provides the source access to a decoy file(s) (Step 344). Based on the warning message, the Read File I/O filter provides the second process with a second application view of the folder that includes the decoy file along with one or more of the folder's files. In some embodiments, the decoy file comprises random data and has a particular type of bait file extension. The bait file extension is defined as a type of file extension that results in a high likelihood that the second process will attempt to interact with the decoy file before interacting with any other files in the second application view of the folder. For example, the file extension may be “.acd”.

The Filter Engine detects a file system operation request for a decoy file by the source (Step 346). If the Write File I/O filter receives a request for a write call operation from the second process to execute a write operation on the decoy file, this indicates the second process has been baited by the file extension of the decoy file because only the second process has access to the decoy file via its second application view of the folder. The Write File I/O filter responds by initiating one or more operations to terminate the second process and sends a message back to the supervisor component providing log data reporting that the second process requested a write operation on the decoy file and that it was terminated.

The Filter Engine performs file attribute analysis (step 348). In various embodiments, the second process may not initially request any type of file system operation for the decoy file or may not ever request file system operations that implicate the decoy file. In such a circumstance, the lack of a file system operation request specifically related to the decoy file maintains the status of the second process as suspicious. As the second process requests various file system operations targeted to the folder and one or more of the folders' files, one or more of the various File I/O filters execute an ongoing file attribute analysis to determine whether the second process's subsequent file system activities indicate that its status should no longer suspicious and, rather, that the second process can be identified as being associated with a malicious program or ransomware.

The file attribute analysis performed by any respective File I/O filter includes two phases. The first phase is checking for modifications of file extensions of one or more files in the folder. If modified file extensions match pre-defined file extensions associated with various types of malicious programs or ransomware, the respective File I/O filter triggers the second phase. During the second phase, the respective File I/O filter calculates a Shannon Entropy measurement related to the results of one or more of the subsequent file system operations performed by the second process. Upon determining that a Shannon Entropy measurement is greater than a predefined entropy threshold, the respective File I/O filter updates the status of the second process as being associated with a malicious program or ransomware. The respective File I/O filter terminates the second process and sends a message back to the supervisor component providing log data reporting that the second process has been terminated based on file attribute analysis—as opposed to requested a certain type of file system operation for the decoy file.

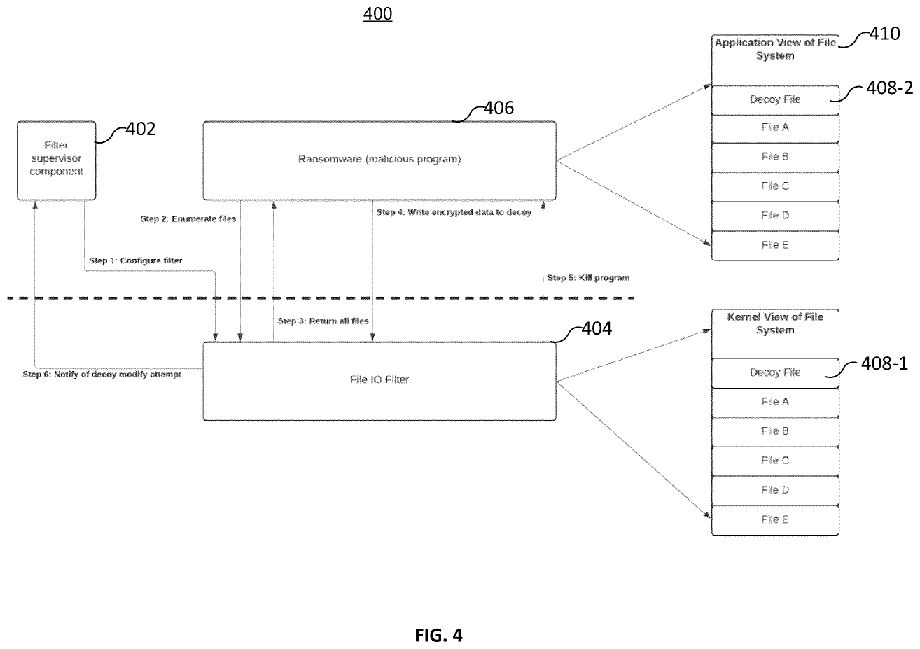

As shown in the diagram 400 of FIG. 4, there may be one or more File I/O filters 404. The File I/O filter 404 may be synchronous meaning that it serves as an in-the-loop hook where the requested file system operation doesn't execute until it has gone through the File I/O filter first 404. This feature allows for the killing of the calling process (or source) 406 if the filter logic returns that the calling process 406 is malicious and the filter 404 is in prevention mode. The File I/O filter 404 has the capacity to prevent intercepted file system operations from being executed. Additionally, the filter 404 has a detection mode, in which the file system operation is still allowed to execute.

The supervisory component 402 comprises the configuration, decision, and reporting layer of the decoy logic and file analysis logic of the Filter Engine. Configuration refers to registering (or assigning) the delegated filter logic functions with the filter 404. The decision layer refers to the delegate filter logic functions performed by a filter 404. These perform the actual decoy logic and file analysis logic. The reporting layer simply reports on notable events occurring within the decoy logic or file analysis logic.

The decoy logic implemented by the component 402 assesses whether or not the calling process (or source 406) of an intercepted file system operation request is present on a list of allowed applications and programs (“allowed list”) considered to have a legitimate purpose for having access to on or more folders. If the source 406 is present on the allowed list, the decoy logic of the Filter Engine returns a message to the File I/O filter 404 that the decoy file 408-1 need not be enumerated.

If the source 406 is not on the allowed list, the decoy logic triggers enumeration of the decoy file 408-2 so that it will be visible to the suspicious source 406. This increases the potential for programs that modify all the files in a directory such as ransomware to subsequently modify the decoy file 408-2. The decoy file 408-2 may have a certain type of file extension that is capable of baiting the source 406 to request an operation for the decoy file 408-2 as opposed to other files.

The decoy logic flags changes to the decoy file 408-2. For example, after enumeration, if the source 406 proceeds to modify the decoy file 408-2, the filter 404 may at the very least report the modification incident to an event sink, such as the windows event log. In the event that the filter 404 is in prevention mode, the filter 404 will terminate the source 406 based on its modification of the decoy file 408-2.

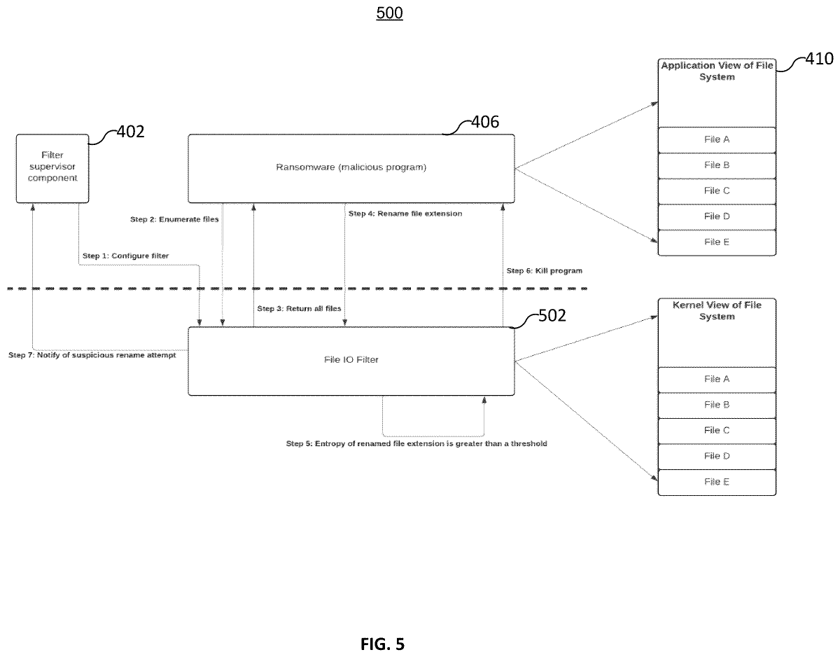

As shown in the diagram 500 of FIG. 5, file attribute analysis logic implemented by the filter supervisory component 402 assesses whether or not the source 406 affect any of the files in an anomalous way. It does so most commonly with thresholding. Unlike the decoy logic, file attribute analysis logic applies to all files and not just the decoy file 408-2.

According to one embodiment, file attribute analysis logic checks for file extension renaming entropy. It is common for ransomware to use double extensions for encrypted files and it happens to be that extension names commonly result in a higher entropy value than ordinary double extensions, such as txt.conti. The file extension entropy analysis will allow ordinary renaming operations to be performed.

Upon detection of a file extension renaming that yields a high entropy that exceeds a predefine threshold, the file attribute analysis logic will at the very least report on this incident to the event sink. If the filter 404 is in prevention mode, the file attribute analysis logic will request of the filter 404 to terminate the source 406.

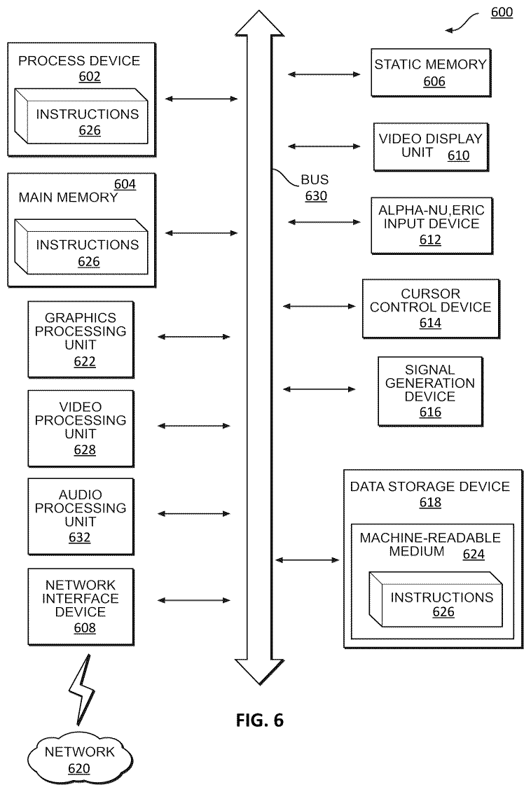

FIG. 6 illustrates an example machine of a computer system within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage device 618, which communicate with each other via a bus 630.

Processing device 602 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein.

The computer system 600 may further include a network interface device 608 to communicate over the network 620. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), a graphics processing unit 622, a signal generation device 616 (e.g., a speaker), graphics processing unit 622, video processing unit 628, and audio processing unit 632.

The data storage device 618 may include a machine-readable storage medium 624 (also known as a computer-readable medium) on which is stored one or more sets of instructions or software 626 embodying any one or more of the methodologies or functions described herein. The instructions 626 may also reside, completely or at least partially, within the main memory 604 and/or within the processing device 602 during execution thereof by the computer system 600, the main memory 604 and the processing device 602 also constituting machine-readable storage media.

In one implementation, the instructions 626 include instructions to implement functionality corresponding to the components of a device to perform the disclosure herein. While the machine-readable storage medium 624 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A computer-implemented method, comprising:
instantiating one or more file input/output (“file I/O”) filter modules that correspond with a file system, each respective file I/O module assigned to a different type of file system operation;
prior to execution of an instance of a first type of file system operation:
(i) detecting, by a first file I/O filter module, a first call for the instance of the first type of file system operation, the first file I/O filter module assigned to the first type of file system operation; and
(ii) determining, by the first file I/O filter module, whether to provide access to file system decoy data to a source of the first call.

2. The computer-implemented method of claim 1, wherein detecting the first call comprises:
intercepting, by the first file I/O filter module, a first request for the instance of the first type of file system operations sent from the source;
routing, by the first file I/O filter module, the intercepted first request to a supervisor component, the supervisor component comprising a list of allowed programs.

3. The computer-implemented method of claim 2, further comprising:
wherein the first file I/O filter module is installed in kernel space;
wherein the supervisor component is installed in user space.

4. The computer-implemented method of claim 1, wherein determining whether to provide access to file system decoy data comprises:
receiving, by the first file I/O filter module, an indication from the supervisor component that the source is associated with a program that is absent from the list of allowed programs; and
due to the program's absence on the list of allowed programs, providing the source of the first call, by the first file I/O filter module, access to file system decoy data (“decoy data”).

5. The computer-implemented method of claim 4, wherein a decoy file comprises the decoy data and a bait file extension.

6. The computer-implemented method of claim 4, further comprising:
detecting, by a second file I/O filter module, a second call by the source for a second type of file system operation for the decoy data, the second file I/O filter module assigned to the second type of file system operations; and
due to the second call requesting a respective file system operation on the decoy data:
initiating, by the second file I/O filter, one or more termination operations for the source.

7. The computer-implemented method of claim 4, further comprising:
prior to any respective file I/O filters detecting subsequent calls for file system operations on the decoy data:
(i) performing, by one or more of the respective file I/O filters, ongoing file attribute analysis; and
(ii) based on a particular result of the file attribute analysis, initiating, by one or more of the respective file I/O filters, one or more termination operations for the source.

8. A system comprising one or more processors, and a non-transitory computer-readable medium including one or more sequences of instructions that, when executed by the one or more processors, cause the system to perform operations comprising:
instantiating one or more file input/output (“file I/O”) filter modules that correspond with a file system, each respective file I/O module assigned to a different type of file system operation;
prior to execution of an instance of a first type of file system operation:
(i) detecting, by a first file I/O filter module, a first call for the instance of the first type of file system operation, the first file I/O filter module assigned to the first type of file system operation; and
(ii) determining, by the first file I/O filter module, whether to provide access to file system decoy data to a source of the first call.

9. The system of claim 8, wherein detecting the first call comprises:
intercepting, by the first file I/O filter module, a first request for the instance of the first type of file system operations sent from the source;
routing, by the first file I/O filter module, the intercepted first request to a supervisor component, the supervisor component comprising a list of allowed programs.

10. The system of claim 9, further comprising:
wherein the first file I/O filter module is installed in kernel space;
wherein the supervisor component is installed in user space.

11. The system of claim 8, wherein determining whether to provide access to file system decoy data comprises:
receiving, by the first file I/O filter module, an indication from the supervisor component that the source is associated with a program that is absent from the list of allowed programs; and
due to the program's absence on the list of allowed programs, providing the source of the first call, by the first file I/O filter module, access to file system decoy data (“decoy data”).

12. The system of claim 11, wherein a decoy file comprises the decoy data and a bait file extension.

13. The system of claim 11, further comprising:
detecting, by a second file I/O filter module, a second call by the source for a second type of file system operation for the decoy data, the second file I/O filter module assigned to the second type of file system operations; and
due to the second call requesting a respective file system operation on the decoy data:
initiating, by the second file I/O filter, one or more termination operations for the source.

14. The system of claim 11 further comprising:
prior to any respective file I/O filters detecting subsequent calls for file system operations on the decoy data:
(i) performing, by one or more of the respective file I/O filters, ongoing file attribute analysis; and
(ii) based on a particular result of the file attribute analysis, initiating, by one or more of the respective file I/O filters, one or more termination operations for the source.

15. A computer program product comprising a non-transitory computer-readable medium having a computer-readable program code embodied therein to be executed by one or more processors, the program code including instructions to:
instantiating one or more file input/output (“file I/O”) filter modules that correspond with a file system, each respective file I/O module assigned to a different type of file system operation;
prior to execution of an instance of a first type of file system operation:
(i) detecting, by a first file I/O filter module, a first call for the instance of the first type of file system operation, the first file I/O filter module assigned to the first type of file system operation; and
(ii) determining, by the first file I/O filter module, whether to provide access to file system decoy data to a source of the first call.

16. The computer program product of claim 8, wherein detecting the first call comprises:
intercepting, by the first file I/O filter module, a first request for the instance of the first type of file system operations sent from the source;
routing, by the first file I/O filter module, the intercepted first request to a supervisor component, the supervisor component comprising a list of allowed programs.

17. The computer program product of claim 9, further comprising:
wherein the first file I/O filter module is installed in kernel space;
wherein the supervisor component is installed in user space.

18. The computer program product of claim 8, wherein determining whether to provide access to file system decoy data comprises:
receiving, by the first file I/O filter module, an indication from the supervisor component that the source is associated with a program that is absent from the list of allowed programs; and
due to the program's absence on the list of allowed programs, providing the source of the first call, by the first file I/O filter module, access to file system decoy data (“decoy data”).

19. The computer program product of claim 11, further comprising:
detecting, by a second file I/O filter module, a second call by the source for a second type of file system operation for the decoy data, the second file I/O filter module assigned to the second type of file system operations; and
due to the second call requesting a respective file system operation on the decoy data:
initiating, by the second file I/O filter, one or more termination operations for the source;
wherein a decoy file comprises the decoy data and a bait file extension.

20. The computer program product of claim 11 further comprising:
prior to any respective file I/O filters detecting subsequent calls for file system operations on the decoy data:
(i) performing, by one or more of the respective file I/O filters, ongoing file attribute analysis; and
(ii) based on a particular result of the file attribute analysis, initiating, by one or more of the respective file I/O filters, one or more termination operations for the source.
